(19) United States
(12) Patent Application Publication
(10) Pub. No.: US 2003/0150305 A1
(43) Pub. Date: Aug. 14, 2003

(54) New portable vinyl siding and aluminum cutting tool

(76) Inventor: Terry Fisher, Brighton, MI (US)

Correspondence Address: Robert A. Dunn, Dinnin & Dunn, P.C., 2701 Cambridge Ct, Ste. 500, Auburn Hills, MI, 48326, US

(21) Appl. No.: 10/015,308

(22) Filed: Dec. 12, 2001

(51) Int. Cl. B23D 19/04; B26D 1/24

(52) U.S. Cl. 83/13; 83/56; 83/500; 83/614

(57) ABSTRACT

A cutting tool is provided, comprising a guide member with a channel, attached to a support arm. A body piece is also provided, and has an attached handle and cutting assembly. The body piece may be positioned at any point along the support arm, its cutting assembly thus being positionable to select a cut line such that a workpiece may be severed or scored at virtually any width desired. A method of cutting a sheet material is also provided, which employs the aforementioned cutting tool.

### TECHNICAL FIELD

The present invention relates generally to cutting tools and, more particularly, to a handheld cutting tool for cutting sheet material.

### BACKGROUND OF THE INVENTION

A variety of designs for cutting sheet material, such as vinyl or aluminum siding, have been developed over the years. There is always room for improvement however, and particularly where it is desirable to cut such materials in a lengthwise fashion. Conventional tin snips have been widely used for this purpose, however, they are relatively slow and highly labor intensive.

U.S. Pat. No. 5,010,795 to Kania discloses an Apparatus for Cutting Metal and Plastic Sheet. The Kania apparatus allows sheet material to be fed across a cutting die, then cut widthwise to the desired length with a single cutting stroke. Kania represents one design, however, the width/length of the cut is limited by the dimensions of the cutter blade. Moreover, the apparatus is relatively bulky and heavy.

U.S. Pat. No. 3,986,418 to Lang et al. discloses a System for Making Cutouts and Angular Cuts in Stepped Siding. Lang achieves its objective, however, it does not facilitate making longitudinal cuts in a workpiece, and the apparatus is bulky and difficult to use.

Portable laminate cutters of the type manufactured by Virutex, S.A. represent a third approach to cutting sheet material. The Virutex cutter is directed to cutting relatively thin sheets of material, for example, plastics, laminates, and veneer. A possible advantage is that the cutter is relatively small and light. However, the device is overly complex and poorly suited for cutting materials of varying thickness.

It is thus desirable to develop a relatively simple and easily manufactured cutter, capable of cutting sheet material lengthwise at varying widths, and adaptable to cut sheets of varying thickness.

The present invention is directed to one or more of the problems or shortcomings associated with the prior art.

### SUMMARY OF THE INVENTION

In one aspect, a cutting tool for a sheet material is provided which comprises a guide member attached to a support arm. The guide member also includes a workpiece guide that is preferably a guide channel. The cutting tool further comprises a body piece having a handle, the body piece being coupled to a support arm. At least one cutting member is included on the body piece, and the body piece can be moved relative to a workpiece positioned by the guide channel. Moving the workpiece longitudinally through the cutting tool or, alternatively, moving the tool longitudinally along the workpiece, engages the at least one cutting member and the workpiece at a cut line.

In another aspect, a method of cutting a sheet material is provided. The method comprises the step of providing a guide member that is attached to a support arm, the guide member including workpiece guide means. The method further comprises the step of providing a body piece with a handle, coupled to the support arm. Further, the method comprises the step of providing at least one cutting member included on the body piece, and selecting a cutting width. Still further, the method comprises the step of moving the body piece relative to a workpiece positioned by the guide means, thereby engaging the at least one cutting member and the workpiece at a cut line to effect a cutting or scoring thereof.

In still another aspect, a cutting tool for sheet material is provided, comprising a guide member with a longitudinal channel for receipt of a workpiece. The cutting tool also comprises a support arm, positioned essentially perpendicular to the guide member, and attached to the guide member. The cutting tool also comprises a cube-shaped body piece that includes a cutter, and has an attached handle. The body piece is movable in a longitudinal direction relative to the workpiece. This engages the cutter with the workpiece for cutting. The body piece is also slidable along the support arm, and can be positioned at varying distances from the guide member. The distance between the guide member and the cutter/body piece thus defines a workpiece cutting width.

In still another aspect, a cutting tool for sheet material is provided. The cutting tool comprises a guide member attached to a support arm, and a body piece with a handle, coupled to the support arm. The cutting tool further comprises a cutting assembly included on the body piece which is movable relative to the support arm. The body piece and the included cutting assembly are movable relative to a workpiece positioned at least in part by the guide member, thereby engaging the cutting assembly and the workpiece at a cut line. The cutting assembly comprises a holder member and two opposed cutting wheels, which act to cut the workpiece at the cut line.

### BRIEF DESCRIPTION OF THE DRAWINGS

FIG. 1 is an elevational view of a preferred embodiment of the present invention;

FIG. 2 is a left side view of the preferred embodiment of the invention shown in FIG. 1;

FIG. 3 is a top view of the embodiment of the invention of FIG. 1;

FIG. 4 is a rear view of the embodiment of the invention of FIG. 1;

FIG. 5 is an exploded view of the invention of FIG. 1.

### DETAILED DESCRIPTION

Referring to the drawing Figures, there is shown a cutting tool 10 according to a preferred constructed embodiment of the present invention. Cutting tool 10 includes a guide member 14, which is preferably metallic, for controlling the relative position of a workpiece 100. Guide member 14 is preferably substantially C-shaped in cross section, and has a back portion 14a and two side portions 14b. The angle Θ between the back portion 14a and the side portions 14b is preferably slightly greater than 90 degrees. The workpiece may be any of a wide variety of sheet materials, although it is contemplated that the present invention will most often be used to sever vinyl siding. Although guide member 14 preferably includes a guide channel 16, it should be appreciated that some other method of guiding the workpiece such as rollers, a trough, or even a simple backing plate might be substituted without departing from the intended scope of the present invention.

Cutting tool 10 further includes a support arm 18 that is preferably a metallic bar with a rectangular cross section although, among other things, a cylindrical bar might be substituted. Support arm 18 is attached to guide member 14, and may be affixed with bolts, screws, welds, or some other suitable attachment method. Support arm 18 preferably includes an arcuate portion 19, however, this feature is not indispensable, as described below. Cutting tool 10 further comprises a body piece 20 with an attached handle 12. Body piece 20 is preferably a metallic cube with a hollow interior and an open face 26, allowing manipulation of the component attachments therein (described below). Handle 12 may be constructed of wood, plastic, metal, or any other suitable material. In a preferred embodiment, handle 12 is a single internally threaded, roughly cylindrical piece attached to body piece 20 with a nut and bolt (not shown), however, a different design might be substituted. For instance, gripping indentations might be added to handle 12, or an angled or arcuate handle might be used.

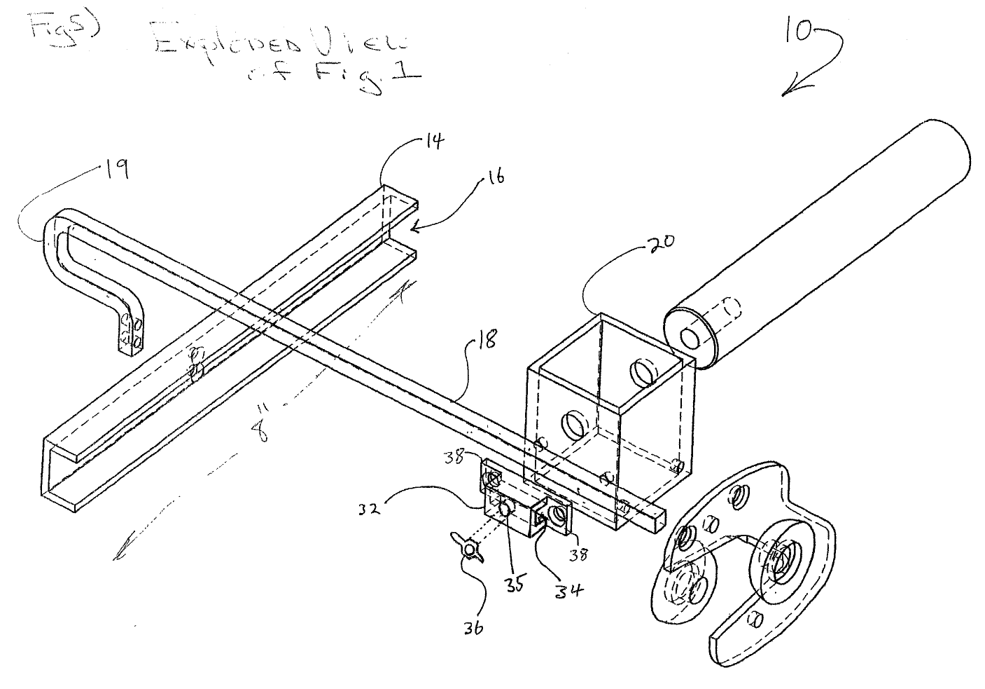

At least one cutter 21 is attached to body piece 20, and preferably includes a holder member 22, which is attached to body piece 20 with bolts, screws, or some other suitable attachment. Holder member 22 is preferably a single metallic piece with an upper portion 23 to which a rotatable upper cutting wheel 28 is attached, a lower portion 25 to which a rotatable lower cutting wheel 30 is attached, and a medial portion 24 which connects upper portion 23 to lower portion 25, and is oriented perpendicular to portions 23 and 25. Holder member 22 may be machined out of a single block of metal, or it may be constructed by bending a relatively thin metal strip. Referring to FIG. 4, there is shown a rear view of the preferred embodiment of the present invention. Upper cutting wheel 28 is preferably metallic, and has a first cutting surface 29, which is an edge 29 separating a flat side 31 from a rounded side 32. Lower cutting wheel 30 is substantially identical to upper cutting wheel 28, and preferably has a second cutting surface 31. Cutting wheels 28 and 30 preferably face opposite directions, and the interface of first and second cutting surfaces 29 and 31 defines a cut line on the workpiece (not shown). As illustrated, upper cutting wheel 28 and lower cutting wheel 30 are positioned such that their respective cutting surfaces occupy substantially the same plane Z, the intersection of plane Z and the workpiece corresponds to the cut line.

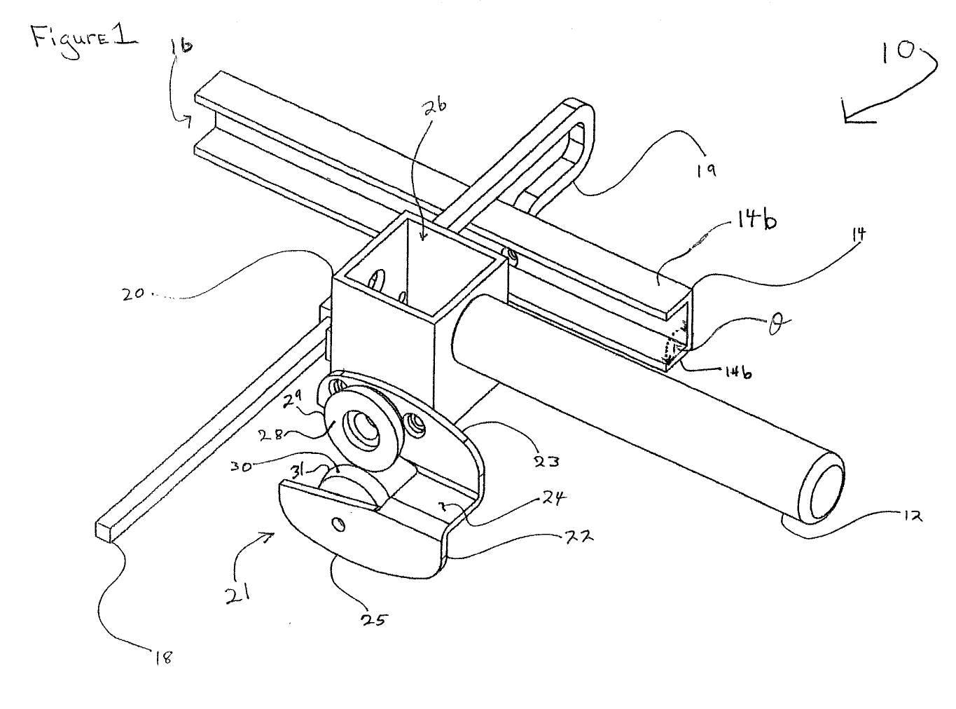

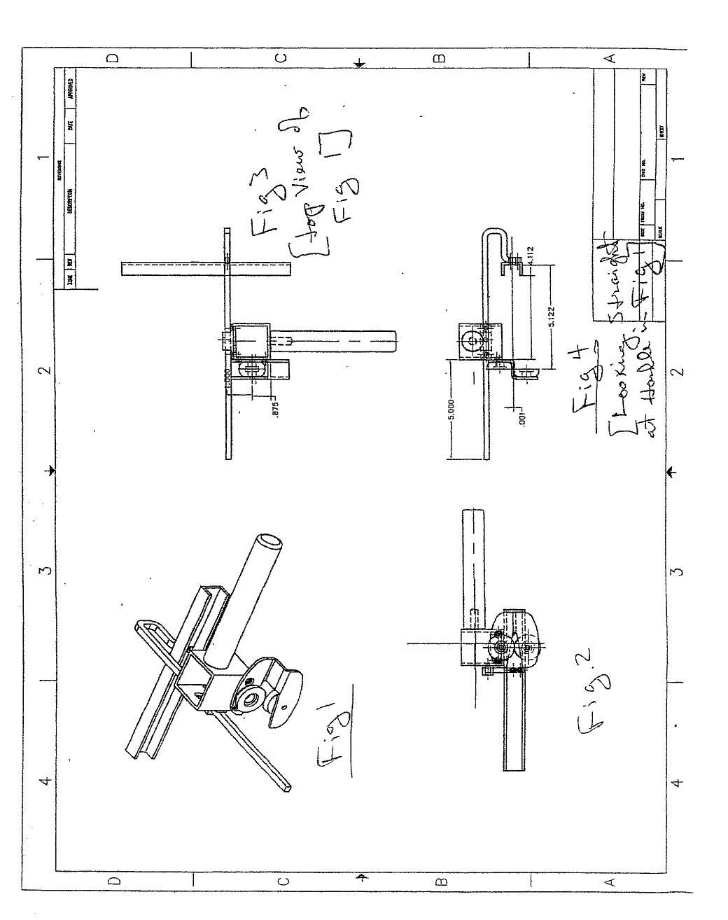

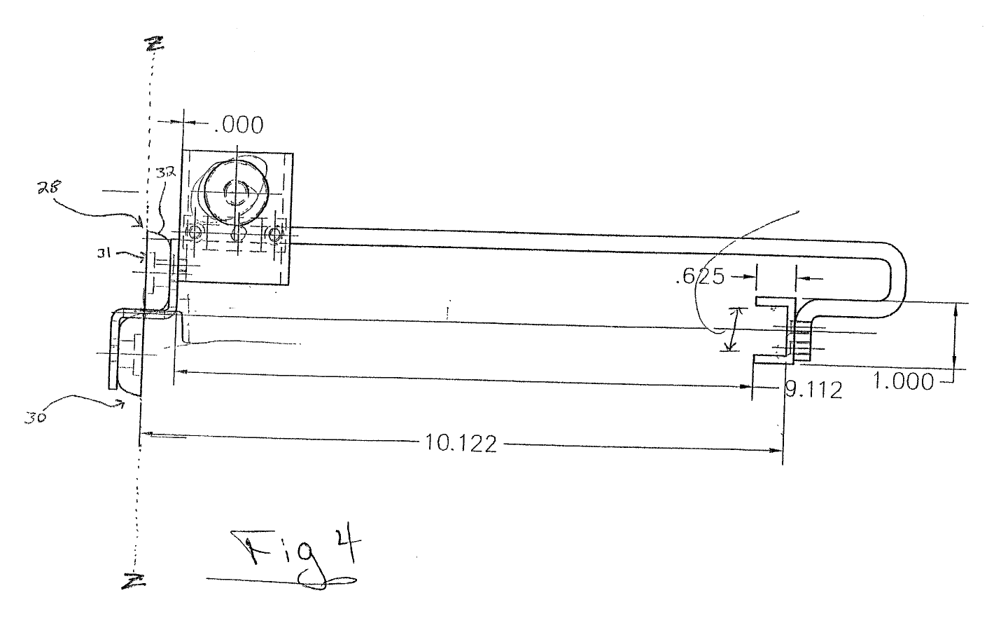

Referring to FIG. 5, there is shown an exploded view of the preferred embodiment of the present invention shown in FIG. 1. FIG. 5 illustrates a slider member 32 that is attached to body piece 20, preferably with bolts or screws via two ears 38. It should be appreciated that a separate slider member is not necessary. For example, body piece 20 might be fashioned such that it could be slidably mounted directly onto support arm 18, however, the use of the separate slider member 32 is preferred. A channel 34 with a generally square cross section penetrates through slider member 32, and slidably receives support arm 18. A wing bolt 36 is preferably provided, and is threadedly received in a bore 35 in slider member 32. Wing bolt 36 may be tightened in bore 35 to bring the base of its shaft into contact with support arm 18. In this manner, wing bolt 36 can be used to secure slider member 32, and thus the attached body piece 20 at a selected position on support arm 18. Measuring markings are preferably embossed on support arm 18, allowing the body piece 20 to be positioned on support arm 18 at any desired distance from guide member 14. Support arm 18's arcuate portion 19 extends in a direction transverse to the lengthwise orientation of guide member 14, and thus allows body piece 10 to be secured to support arm 18 at positions on either side of guide member 14. In this manner, cutting assembly 21 may be brought approximately flush with guide member 14. The invention might be constructed without arcuate portion 19, however, the flexibility in available workpiece cutting widths would be reduced. Because the edge of a workpiece is positioned by guide member 14 within guide channel 16, the present invention allows a cut line to be positioned at virtually any distance from the edge of the workpiece.

Referring to the drawing Figures generally, when cutting of a workpiece is desired, the edge of the workpiece should be fed into guide channel 16, and body piece 20 positioned and secured along support arm 18 such that the cut line will be at the desired distance from the edge of the workpiece. Cutting assembly 21 can then be positioned adjacent a leading edge of the workpiece, and pressure applied to handle 12 to drive the cutter assembly 21 forward, severing the workpiece in a longitudinal fashion. As the cutting process progresses, the workpiece is cut into two strips, the respective strips separating to the two respective sides of holder member 22's upper portion 23. In an embodiment wherein a disengagement armature is employed (not shown), cutting of the workpiece can be initiated and terminated by engaging or disengaging the cutter members 28 and 30. Thus, that embodiment allows a workpiece to be cut at certain positions along its length, and left intact along other positions along its length. This process (embodiment) is useful when, for example, a piece of vinyl siding is desired with a discontinuous edge, as might be fitted around the top of a window in the wall of a house.

It should be understood that the present description is for illustrative purposes only, and should not be construed to limit the present invention in any way. Thus, those skilled in the art will appreciate that various alterations to the previously disclosed embodiments might be made without departing from the intended spirit and scope of the invention. For example, although a preferred constructed embodiment preferably includes the aforementioned set of two cutting wheels, 28 and 30, the cutter assembly employed might be varied substantially from the presently disclosed embodiments. A single knife blade might be substituted, and affixed to body piece 20 for cutting the workpiece. Further, it is not necessary for purposes of the present invention that the workpiece actually be severed. A scoring tool such as a file or similar instrument might be affixed to body piece 20, allowing the workpiece to be scored and, for example, later broken by hand along the score line. Thus, although the workpieces most preferably used with the present invention are sheets of vinyl siding, the present invention might find application to other materials, for instance various glasses, plastics, tile, or masonite.

Other aspects, features, and advantages of the present invention will be evident upon examination of the attached drawing figures and appended claims.

1. A cutting tool for sheet material, comprising:
a guide member attached to a support arm;
a body piece with a handle, coupled to said support arm; and
a cutting assembly included on said body piece and movable relative to said support arm;
said body piece and said included cutting assembly being movable relative to a workpiece positioned at least in part by said guide member, thereby engaging said cutting assembly and said workpiece at a cut line.

2. The cutting tool of claim 1 wherein said cutting assembly comprises a holder member and two cutter wheels.

3. The cutting tool of claim 2 wherein said holder member has an upper portion, a medial portion, and a lower portion;
an upper cutter wheel is attached to said upper portion and includes a first cutting surface; and
a lower cutter wheel is attached to said lower portion and includes a second cutting surface;
the interface of said first and said second cutting surfaces defines said cut line on said workpiece.

4. The cutting tool of claim 3 wherein said holder member comprises a unitary piece.

5. The cutting tool of claim 1 wherein said body piece is a cube coupled to said support arm by a slider member;
said slider member includes an interior channel with a generally square cross section which slidably receives said support arm, and is securable to said support arm with a wing bolt;
said body piece is slidable along said support arm in a direction transverse to the orientation of said guide member, thereby varying the distance between said cut line and an edge of said workpiece positioned by said guide member.

6. The cutting tool of claim 1 wherein said guide member comprises a roughly C-shaped cross section with an open side and a channel which slidably receives an edge of a workpiece;
said channel prevents motion of said workpiece in a direction perpendicular to a cutting direction, directing said workpiece through said cutter assembly in a substantially straight line.

7. A method of cutting sheeted material, comprising the steps of:
providing a guide member attached to a support arm, the guide member including workpiece guide means;
providing a body piece with a handle, coupled to the support arm; and
providing at least one cutter included on the body piece;
selecting a cutting width by moving the cutter relative to the guide member; and
moving the body piece relative to a workpiece positioned by the guide means, thereby engaging the cutter and the workpiece at a cut line to effect a cutting or scoring thereof.

8. The method of claim 8 wherein the selecting step comprises sliding the body piece in a direction transverse to an orientation of the guide member, and securing the body piece with a wing bolt, thereby positioning the cutter a predetermined distance from the guide member, the predetermined distance defining a workpiece cutting width.

9. A cutting tool for sheet material comprising:
a guide member with a longitudinal channel for receipt of a workpiece;
a support arm positioned essentially perpendicular to said guide member, and attached thereto;
a cube shaped body piece including a cutter, having an attached handle, wherein said body piece is movable in a longitudinal direction relative to said workpiece, thereby engaging said cutter with said workpiece for cutting thereof; and
said body piece is slidably coupled to said support arm, and positionable at varying distances from said guide member, said distances defining a workpiece cutting width.

10. The cutting tool of claim 11 wherein said cutter comprises a holder member with an upper cutter wheel and a lower cutter wheel;
said upper and said lower cutter wheels each including a cutting surface;
said cutting surfaces being positioned in substantially the same plane, said plane defining a cut line on said workpiece.

11. The cutting tool of claim 11 wherein said body piece is slidably coupled to said support arm with a slider member;
said slider member receives said support arm in a close clearance fashion, and is securable thereto with a wing bolt, affixing said body piece and the associated cutter to said support arm.

12. A cutting tool for sheet material, comprising:
a guide member attached to a support arm;
a body piece with a handle, coupled to said support arm; and
a cutting assembly included on said body piece and movable relative to said support arm;
said body piece and said included cutting assembly being movable relative to a workpiece positioned at least in part by said guide member, thereby engaging said cutting assembly and said workpiece at a cut line; and
wherein said cutting assembly comprises a holder member and two opposed cutter wheels, which act to cut the workpiece at the cut line.

13. The cutting tool of claim 12 wherein said holder member has an upper portion, a medial portion and a lower portion;
an upper cutter wheel is attached to said upper portion and includes a first cutting surface;
a lower cutter wheel is attached to said lower portion and includes a second cutting surface; and
the interface of said first and said second cutting surfaces defines said cut line on said workpiece.

14. The cutting tool of claim 13 wherein said holder member comprises a unitary piece.

15. The cutting tool of claim 14 wherein said body piece is a cube coupled to said support arm by a slider member;
said slider member includes an interior channel with a generally square cross section which slidably receives said support arm, and is securable to said support arm with a wing bolt;
said body piece is slidable along said support arm in a direction transverse to the orientation of said guide member, thereby varying the distance between said cut line and an edge of said workpiece positioned by said guide member.
